(19) United States
(12) Patent Application Publication
(10) Pub. No.: US 2010/0258486 A1
(43) Pub. Date: Oct. 14, 2010

(54) APPARATUS FOR PREVENTION OF MUD HARDENING IN DRAIN HOLDING TANK

(75) Inventors: Ji-Soon Park, Geoje-si (KR); Young-Ho Jung, Geoje-si (KR); Young-Beum Jang, Geoje-si (KR)

Correspondence Address: BRINKS HOFER GILSON & LIONE, P.O. BOX 10395, CHICAGO, IL, 60610, US

(73) Assignee: Samsung Heavy Ind. Co., Ltd., Seocho-Gu (KR)

(21) Appl. No.: 12/822,975

(22) Filed: Jun. 24, 2010

Related U.S. Application Data
(63) Continuation of application No. PCT/KR2008/006713, filed on Nov. 14, 2008.

(30) Foreign Application Priority Data
Dec. 27, 2007 (KR) 10-2007-0138717
Nov. 4, 2008 (KR) 10-2008-0108918

(51) Int. Cl. E21B 21/06; C02F 1/40; E21B 21/01

(52) U.S. Cl. 210/93; 210/172.1; 137/563; 137/565.17; 137/565.29

(57) ABSTRACT

The present invention relates to an apparatus for preventing mud from being hardened in a drain holding tank, in an apparatus that treats drains generated during the marine drilling of petroleum or gas. The apparatus for preventing mud from being hardened in a drain holding tank includes a drain holding tank which gathers a drain being generated in a drilling process; a mud re-compounding pump which circulates a fluid having a pressure that is higher than a predetermined value by spouting the fluid to an area of the drain holding tank where the mud is stored, to prevent mud included in the drain from being hardened in the drain holding tank; a transfer pump which transfers the mud; and a waste mud tank, configured to gather the mud. The apparatus for preventing mud from being hardened in a drain holding tank can circulate the mud at an area of the drain holding tank in which the mud is stored for a period of time, to prevent the mud from being hardened.

### PRIORITY CLAIM

This application is a continuation and claims the benefit of priority under 35 U.S.C. §§120, 365, and 371 to Patent Cooperation Treaty Patent Application No. PCT/KR2008/006713, filed on Nov. 14, 2008. This application further claims the benefit of priority to Korean Application Nos. 10-2007-0138717, filed Dec. 27, 2007 and 10-2008-0108918, filed Nov. 4, 2008. The disclosures of the above applications are incorporated herein by reference in their entireties.

### TECHNICAL FIELD

The present invention relates to an apparatus for treating drain, more specifically to an apparatus for preventing mud from being hardened in a drain holding tank, in an apparatus that treats drain generated during the marine drilling of petroleum or gas.

### RELATED ART

As easily learned from the today's sudden rise of oil prices, the limited earth resources have become gradually exhausted because of the rapid global industrialization and development of industries. Accordingly, it becomes very important to stably produce and supply the resources. Moreover, with the recent development of undersea oil drilling technologies, the marginal fields and deep-sea oil fields, which used to be economically unfeasible, have been increasingly developed.

When the oil is drilled by an oil drill ship, various kinds of drain having oil compounds and mud are generated. If the drain having these oils and mud were discharged without a purification process, this would cause serious marine pollution. Accordingly, the drain generated in the ship should be purified to satisfy predetermined environmental standards. Thus, oil drill ships are equipped with an apparatus for treating the drain.

The conventional drain treating apparatus gathers drain in a drain holding tank from the mud areas or the drilling deck of the ship. The drain has compounds of various oil components and mud. The drain is stored in the drain holding tank for a period of time before being treated. However, if the mud components included in the drain become hardened in the drain holding tank after an extended period of time, this makes it difficult to transfer the drain. Accordingly, if the hardened mud were not removed to transfer the drain smoothly, the general drilling processes would become very inefficient.

FIG. 1 is a brief diagram of a conventional drain treating apparatus of an oil drill ship. Drain 7 is gathered and stored in a drain holding tank 1 for a period of time. While the drain 7 is stored in the drain holding tank 1 for a period of time, the treated water, from which oil components included in the drain 7 are separated, is only discharged to an outside 15 through an oil-water separator 9, an ODME 11 and a discharge pump 13. Mud included in the drain 7, which has been stored for a period of time, becomes hardened. The hardened mud obstructs the transfer of the drain 7 by a mud transfer pump 3 from the drain holding tank 1 to a waste mud tank 5. This makes it difficult to smoothly transfer the drain 7 in the drain holding tank 1. Accordingly, the overall efficiency of the drain treating apparatus is decreased.

As such, in the conventional drain treating apparatus having no additional apparatus for preventing the mud settled on the bottom of the drain holding tank 1 from being hardened, the drain treating was often interrupted by the hardened mud or suffered other corresponding problems during the drilling.

### SUMMARY

The present invention, which is contrived to solve the aforementioned problems of a drain treating apparatus, provides an apparatus for preventing the mud from being hardened in a drain holding tank, especially on the bottom of the drain holding tank, in the drain treating apparatus.

In accordance with an embodiment of the present invention, an apparatus for preventing mud from being hardened in a drain holding tank, includes a drain holding tank, configured to gather drain being generated in a drilling process; a mud re-compounding pump, configured to circulate a fluid material by spouting the fluid material at a pressure that is greater than or equal to a predetermined value to an area of the drain holding tank in which mud is stored, in order to prevent the mud included in the drain from being hardened in the drain holding tank; a transfer pump, configured to transfer the mud; and a waste mud tank, configured to gather the mud.

The apparatus can further include an outlet tube, being connected to one end of the mud re-compounding pump and allowing the drain gathered in the drain holding tank to flow out; and a supply tube, being connected to the other end of the mud re-compounding pump and allowing the drain to be supplied to the drain holding tank.

A plurality of nozzles can be connected to the supply tube in the drain holding tank such that the fluid material is spouted with a high pressure from the supply tube.

At this time, the outlet tube can be connected to the drain holding tank at a position that is higher than a position at which the supply tube is connected to the drain holding tank.

The fluid material can be the drain itself, and the apparatus can further include a holding tank, being connected to one end of the mud re-compounding pump and holding the fluid material being spouted to the drain holding tank. The mud re-compounding pump can be a compressor.

The apparatus can further include an oil-water separator, being connected to the drain holding tank and separating oil from treated water, from which the oil has been removed.

The apparatus can further include oil discharge monitoring equipment, configured to monitor whether the treated water satisfies an environmental standard.

The apparatus can further include a discharge pump, configured to discharge the treated water separated from the drain by the oil-water separator to an outside.

In accordance with an embodiment of the present invention, the apparatus for preventing the mud from being hardened in a drain holding tank can allow a fluid having a pressure that is equal to or greater than a predetermined value to be circulated at a position where the mud of the drain is stored for a period of time by a mud re-compounding pump that discharges the fluid in order to prevent the mud from being hardened.

If the mud is prevented from being hardened, no hardened mud obstructs the transfer of the drain. This can prevent the drilling process from unnecessarily being interrupted, thereby improving the efficiency of the drilling process. This can also alleviate the trouble of having to remove the hardened mud, making the drilling process much easier.

### BRIEF DESCRIPTION OF THE DRAWINGS

FIG. 1 is a brief diagram of a conventional drain treating apparatus of an oil drill ship.

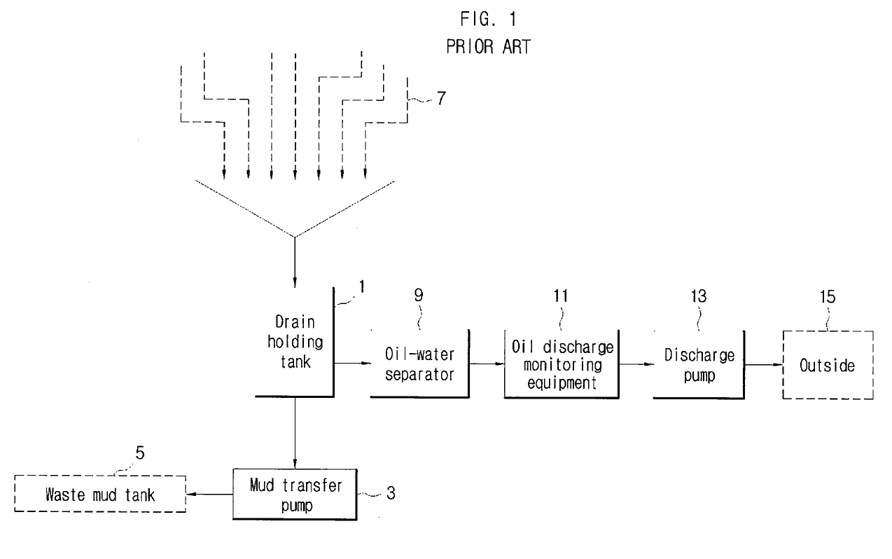

FIG. 2 is a brief diagram of an apparatus for preventing mud from being hardened in a drain holding tank of an oil drill ship in accordance with an embodiment of the present invention.

FIG. 3 is a brief view of a mud re-compounding pump in accordance with an embodiment of the present invention.

FIG. 4 is a brief view of a mud re-compounding pump in accordance with another embodiment of the present invention.

### DETAILED DESCRIPTION OF THE PREFERRED EMBODIMENTS

Hereinafter, an apparatus for preventing mud from being hardened in a holding tank of an oil drill ship in accordance with an embodiment of the present invention will be described in detail with reference to the accompanying drawings. The below detailed examples are merely to describe an apparatus for preventing mud from being hardened in a holding tank of an oil drill ship in accordance with an embodiment of the present invention. This, however, is by no means to restrict the present invention to the examples.

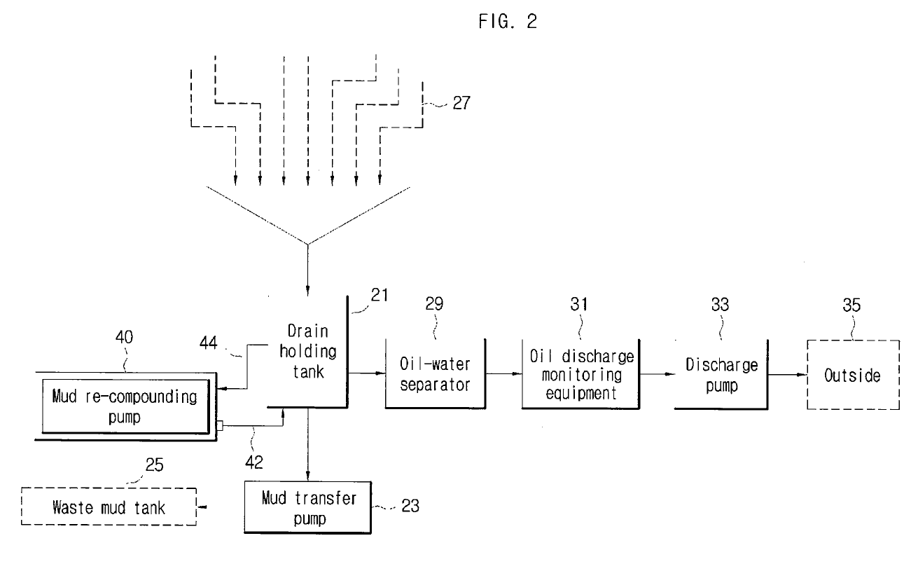

FIG. 2 is a brief diagram of an apparatus for preventing mud from being hardened in a drain holding tank of an oil drill ship in accordance with an embodiment of the present invention. As shown in FIG. 2, the apparatus for preventing mud from being hardened in a drain holding tank of an oil drill ship in accordance with an embodiment of the present invention includes a drain holding tank 21, a mud transfer pump 23, a waste mud tank 25 and a mud re-compounding pump 40.

The drain holding tank 21, which gathers drain 27 generated in a drilling process in the oil drill ship, gathers the drain 27 having the mud, oil components and sea water through a plurality of waterways and water pipes installed around a drilling apparatus. The drain 27 undergoes a treating process and is discharged to an outside 35 or is stored in the drain holding tank 21 for a period of time before being transferred to another tank (e.g. the waste mud tank 25).

The drain 27 gathered in the drain holding tank 21 is transferred to the waste mud tank 25 by the mud transfer pump 23. The drain 27 is usually stored in the waste mud tank 25 before being separately treated later. At this time, if the mud settled on the bottom of drain holding tank 21 were hardened because the mud had been stored in the drain holding tank 21 for a period of time, this would obstruct the transfer of the mud by the mud transfer pump 23 from the drain holding tank 21 to the waste mud tank 25.

Accordingly, it is possible to circulate a fluid material in the drain holding tank 21 by mounting the mud re-compounding pump 40, which is connected to the drain holding tank 21, and spouting the fluid material to the drain holding tank 21 with a pressure that is equal to or greater than a predetermined value. Through such circulation, the drain 27 is maintained in a similar state as if it is continuously transferred, rather than being settled, even though the drain 27 is stored in the drain holding tank 21 for a period of time. Accordingly, the mud components of the drain 27 can be prevented from being hardened in the drain holding tank 21, especially on the bottom of the drain holding tank 21.

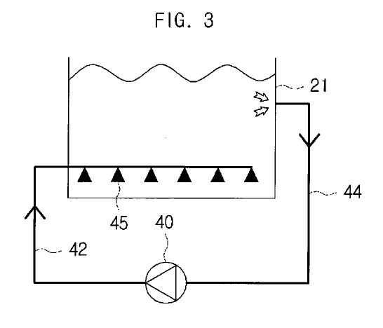

FIG. 3 shows how the mud re-compounding pump 40 circulates the fluid material by being connected to the drain holding tank 21 in accordance with an embodiment of the present invention.

As shown in FIG. 3, the drain 27 gathered in the drain holding tank 21 can be uses as the fluid material that is circulated by the mud re-compounding pump 40. That is, it is possible to circuit the drain 27 stored in the drain holding tank 21 without any additional fluid.

As such, one end of the mud re-compounding pump 40 is connected to an outlet tube 44, through which the drain 27 gathered in the drain holding tank 21 flows out, and the other end of the mud re-compounding pump 40 is connected to a supply tube 42, which supplies the drain 27 to the drain holding tank 21, in order to circulate the drain stored in the drain holding tank 21 by using the mud re-compounding pump 40.

A part of the supply tube 42 is extended to the inside of the drain holding tank 21. A plurality of nozzles 45 can be coupled to the supply tube 42, which is extended to the inside of the drain holding tank 21, to efficiently spout the drain 27 to the inside of the drain holding tank 21. The drain 27 is spouted through the plurality of nozzles 27 located in the drain holding tank 21. As such, if the drain 27 is spouted through each nozzle 45, the drain can be spouted with high pressure. This can efficiently prevent the mud from being hardened on the bottom of the drain holding tank 21.

In the aforementioned structure, the drain 27 can be transferred through the outlet tube 44 and spouted to the drain holding tank 21 through the supply tube 42 by the pumping of the mud re-compounding pump 40 with the pressure that is equal to or greater than a predetermined value in order to circulate the drain 27.

At this time, it is preferable that the outlet tube 44 is connected to the drain holding tank 21 at a position that is higher than the position at which the supply tube 42 is connected to the drain holding tank 21. Especially, the supply tube 42 can be connected to the bottom of the drain holding tank 21, and the nozzle 45 being connected to the supply tube 42 is located at the bottom of the drain holding tank 21.

Of the drain 27 gathered in the drain holding tank 21, heavy materials such as the mud are gathered in a lower part of the drain holding tank 21 over a period of time, and a fluid material such as water or oil is gathered in an upper part of the drain holding tank 21.

Accordingly, the mud gathered in the lower part of the drain holding tank 21 can be prevented from being hardened by connecting the outlet tube 44 to a height, below which the mud is precipitated, to circulate the drain stored in the drain holding tank 21 and by connecting the supply tube 42 to the lower part, in which the mud is expected to be precipitated, to spout the drain.

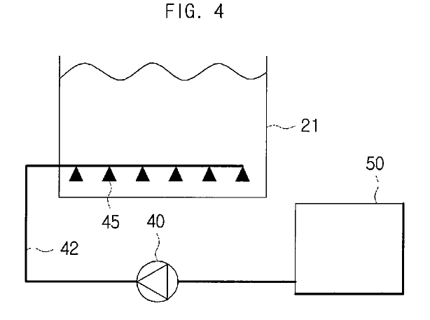

FIG. 4 shows how the mud re-compounding pump 40 circulates the fluid material by being connected to the drain holding tank 21 in accordance with another embodiment of the present invention.

As shown in FIG. 4, seawater, water, air, or gas can be used as the fluid material to be circulated by the mud re-compounding pump 40, instead of the drain 27. At this time, the drain 27 gathered in the drain holding tank 21 can be circulated in the drain holding tank 21 by mounting a holding tank 50, which holds the fluid material such as seawater, water, air, and gas and spouting the fluid stored in the holding tank 50 to the drain holding tank 21.

In the case of using a gaseous material such as air or gas, a compressor can be used instead of the mud re-compounding pump 40. When the treated water is separated from the drain 27 by an oil-water separator 29, which will be described below, and discharged to the outside, the water is removed from the drain. Accordingly, it can be useful to circulate the gaseous material.

When the gaseous material (i.e. a compound of air and gas) stored in the drain holding tank 21 is used as the fluid material to be circulated by the mud re-compounding pump 40, it can be unnecessary to additionally mount the holding tank 50.

The oil-water separator 29 can be included in the drain holding tank 21 in order to separate some components that are permissible for being discharged to the sea from the drain 27 included in the drain holding tank 21 and to discharge the separated components to the outside 35. The oil-water separator 29 is connected to the drain holding tank 21 and receives and treats the drain 27. The oil-water separator 29 can employ a floatation apparatus, which uses the principle that water and oil do not mix and oil floats over water due to their different density, or a centrifuge, which uses the difference of density in water and oil. The oil-water separator 29 separates oil from the drain 27 to allow the treated water having no oil to be discharged to the outside 35. It is necessary to separate oil from water. This is why if oil generated in the drilling process is exposed to the sea by being discharged to the outside 35, this may cause the marine ecosystem to be significantly destroyed. Without the oil-water separator 29, the treated water having no oil is unable to be discharged to the outside 35. The treated water can be discharged through an additional oil-water separating process to be performed later in the outside 35.

At this time, oil discharge monitoring equipment 31 (ODME), which monitors whether the treated water, having undergone the oil-water separating process, satisfies the environmental standards, can be installed to measure a pollution level before the water treated by the oil-water separator 29 is discharged. The ODME 31 can prevent the marine ecosystem from being polluted by allowing the treated water that satisfies the environmental pollution standards (e.g. lower than 15 ppm of the oil component) to be discharged.

The treated water separated by the oil-water separator 29 has less oil than the environmental pollution standards require. As necessary, however, a discharge pump 33 can be mounted to pump the treated water to the outside 35.

Hitherto, examples in which the apparatus for preventing mud from being hardened in a drain holding tank in accordance with certain embodiments of the present invention are mainly applied to a drain holding tank of an oil drill ship. Of course, the apparatus for preventing the mud from being hardened according to an embodiment of the present invention can also be applied to other tanks in which the mud is hardened.

The apparatus for preventing mud from being hardened according to an embodiment of the present invention can prevent mud from being hardened in a drain holding tank by circulating the mud in a drain holding tank.

The apparatus for preventing mud from being hardened according to an embodiment of the present invention can also prevent mud from being hardened in a drain holding tank and the hardened mud from obstructing the transfer of the drain. This can prevent the drilling process from being interrupted, thereby improving the efficiency of the drilling.

We claim:

1. An apparatus for preventing mud from being hardened in a drain holding tank, the apparatus comprising:
a drain holding tank, configured to gather drain being generated in a drilling process;
a mud re-compounding pump, configured to circulate a fluid material by spouting the fluid material at a pressure that is greater than or equal to a predetermined value to an area of the drain holding tank in which mud is stored, in order to prevent the mud included in the drain from being hardened in the drain holding tank;
a transfer pump, configured to transfer the mud; and
a waste mud tank, configured to gather the mud.

2. The apparatus of claim 1, further comprising:
an outlet tube, being connected to one end of the mud re-compounding pump and allowing the drain gathered in the drain holding tank to flow out; and
a supply tube, being connected to the other end of the mud re-compounding pump and allowing the drain to be supplied to the drain holding tank.

3. The apparatus of claim 2, wherein a plurality of nozzles are connected to the supply tube in the drain holding tank such that the fluid material is spouted with a high pressure from the supply tube.

4. The apparatus of claim 2, wherein the outlet tube is connected to the drain holding tank at a position that is higher than a position at which the supply tube is connected to the drain holding tank.

5. The apparatus of claim 1, wherein the fluid material is the drain itself

6. The apparatus of claim 1, further comprising a holding tank, being connected to one end of the mud re-compounding pump and holding the fluid material being spouted to the drain holding tank.

7. The apparatus of claim 1, wherein the mud re-compounding pump is a compressor.

8. The apparatus of claim 1, further comprising an oil-water separator, being connected to the drain holding tank and separating oil from treated water, from which the oil has been removed.

9. The apparatus of claim 8, further comprising oil discharge monitoring equipment, configured to monitor whether the treated water satisfies an environmental standard.

10. The apparatus of claim 8, further comprising a discharge pump, configured to discharge the treated water separated from the drain by the oil-water separator to an outside.
